(19) United States
(12) Patent Application Publication
(10) Pub. No.: US 2024/0042531 A1
(43) Pub. Date: Feb. 8, 2024

(54) Multi-Spade Backspotfacing Tool and Methods of Using Same

(71) Applicant: Jet Machine Works, Inc., Houston, TX (US)

(72) Inventor: Justin Wallace, Splendora, TX (US)

(73) Assignee: Jet Machine Works, Inc., Houston, TX (US)

(21) Appl. No.: 17/880,164

(22) Filed: Aug. 3, 2022

(51) Int. Cl. B23B 51/10

(52) U.S. Cl. CPC B23B 51/102

(57) ABSTRACT

A method of creating a backspotface, comprising providing a backspotface bar, wherein the backspotface bar comprises an axial slit, a first borehole, and a second borehole; inserting the backspotface bar into the chuck of a drill; securing the backspotface bar within the chuck of the drill; inserting the backspotface bar through a hole in a workpiece, wherein the first borehole and the axial slit are positioned on the backside of the workpiece; inserting a spade into the axial slit, wherein the cutting edges of the spade face the workpiece; securing the spade in the axial slit; and activating the drill and engaging the spade with the workpiece.

### BACKGROUND

### 1. Field of Inventions

The field of this application and any resulting patent is a multi-spade backspotfacing tool and methods of using same. More specifically, the field of this application and any resulting patent is a multi-spade backspotfacing tool comprising a spade in a reversed position so that the cutting edges of the spade face the drill and the workpiece.

### 2. Description of Related Art

Various tools and methods have been proposed and utilized for backspotfacing, including some of the tools and methods disclosed in the references appearing on the face of this patent. However, those tools and methods lack all the steps or features of the tools and methods covered by any patent claims below. As will be apparent to a person of ordinary skill in the art, any tools and methods covered by claims of the issued patent solve many of the problems that prior art tools and methods have failed to solve. Also, the tools and methods covered by at least some of the claims of this patent have benefits that could be surprising and unexpected to a person of ordinary skill in the art based on the prior art existing at the time of invention.

Generally, spotfacing is a machined feature in which a certain region of the workpiece (a spot) is faced, providing a smooth, flat, accurately located surface. This is especially relevant on workpieces cast or forged, where the spotface's smooth, flat, accurately located surface stands in distinction to the surrounding surface whose roughness, flatness, and location are subject to wider tolerances and thus not assured with a machining level of precision. The most common application of spotfacing is facing the area around a bolt hole where the head of the bolt will sit, which is often done by cutting a shallow counterbore. A counterbore is a cylindrical flat-bottomed hole that enlarges another coaxial hole. A counterbore hole is typically used when a fastener, such as a socket head cap screw or fillister head screw, is required to sit flush with or below the level of a surface of the workpiece. There may be other applications for spotfacing.

Backspotfacing is analogous to backboring, meaning that the tool manages to reach to the far side of the workpiece (away from the spindle side) and cut back toward the spindle. Current methods of backspotfacing may involve the use of boring bars reaching through a hole while shifted off-center, then shifting onto center for the cut, or with back-deburring style tools whose cutting edges open and close in umbrella-like or check-valve-like fashion. Such back-cutting operations can obviate second operations, with their attendant setup time and part rehandling time. One of the benefits of the inventions disclosed and described in this application and the resulting patent is that the spade in the multi-spade backspotfacing tool is in a reversed position so that the cutting edges of the spade face the drill and the workpiece while in operation. This allows for reduced setup time and part rehandling time.

### SUMMARY

One or more specific embodiments disclosed herein includes a method of creating a backspotface, comprising providing a backspotface bar, wherein the backspotface bar comprises a first end, wherein the first end comprises an axial slit and a first borehole for receiving a first set screw, and a second end, wherein the second end comprises a second borehole for receiving a second set screw; inserting the second end of the backspotface bar into the chuck of a drill, wherein the backspotface bar is inserted to a depth allowing for the second borehole to line up with a drill borehole in the chuck of the drill; securing the backspotface bar within the chuck of the drill; inserting the first end of the backspotface bar through a hole in a workpiece, wherein the first borehole and the axial slit are positioned on the backside of the workpiece; inserting a spade into the axial slit, wherein the cutting edges of the spade face the workpiece; securing the spade in the axial slit by threading the first set screw into the first borehole until the first set screw engages the spade; and activating the drill and engaging the spade with the workpiece.

One or more specific embodiments disclosed herein includes a method of creating a backspotface, comprising first, providing a backspotface bar, wherein the backspotface bar comprises a first end, wherein the first end comprises an axial slit and a first borehole for receiving a first set screw, and a second end, wherein the second end comprises a second borehole for receiving a second set screw; second, providing a workpiece, wherein the workpiece comprises a hole; third, inserting a spade into the axial slit, wherein the cutting edges of the spade face away from the first end; fourth, securing the spade in the axial slit by threading the first set screw into the first borehole until the first set screw engages the spade; fifth, inserting the second end of the backspotface bar through the hole in the workpiece, wherein the first borehole and the axial slit are positioned on the backside of the workpiece; sixth, inserting the second end of the backspotface bar into the chuck of a drill, wherein the backspotface bar is inserted to a depth allowing for the second borehole to line up with a drill borehole in the chuck of the drill; seventh, securing the backspotface bar within the chuck of the drill; and eighth, activating the drill and engaging the spade with the workpiece.

One or more specific embodiments disclosed herein includes a method of creating a backspotface, comprising providing a backspotface bar, wherein the backspotface bar comprises a first end, wherein the first end comprises a slit and a plurality of boreholes, and a second end; inserting the second end of the backspotface bar into the chuck of a drill; securing the backspotface bar within the chuck of the drill; inserting the first end of the backspotface bar through a hole in a workpiece, wherein the first borehole and the slit are positioned on the backside of the workpiece; inserting a spade into the slit, wherein the cutting edges of the spade face the workpiece; securing the spade in the slit by threading a set screw into each of the plurality of boreholes; and activating the drill and engaging the spade with the workpiece.

### BRIEF DESCRIPTION OF THE DRAWINGS

FIG. 1 shows a perspective view of an embodiment of a multi-spade backspotfacing tool.

FIG. 2 shows a perspective view of an embodiment of a multi-spade backspotfacing tool with a drilling apparatus.

FIG. 3 shows a perspective view of an embodiment of a multi-spade backspotfacing tool with a bushing.

FIG. 4 shows a side view of an embodiment of a multi-spade backspotfacing tool.

FIG. 5 shows a perspective view of an embodiment of a multi-spade backspotfacing tool detached from a drilling apparatus.

FIG. 6 shows a side view of an embodiment of a multi-spade backspotfacing tool with a drilling apparatus.

FIG. 7 shows a perspective view of an embodiment of a multi-spade backspotfacing tool with a bushing and a drilling apparatus.

FIG. 8 shows a perspective view of an embodiment of a multi-spade backspotfacing tool inserted through a workpiece.

FIG. 9 shows a partial perspective view of an alternative embodiment of a multi-spade backspotfacing tool.

FIG. 10 shows a perspective view of an alternative embodiment of a multi-spade backspotfacing tool.

FIG. 11 shows a perspective view of an alternative embodiment of a multi-spade backspotfacing tool.

FIG. 12 shows a top perspective view of an alternative embodiment of a multi-spade backspotfacing tool.

FIG. 13 shows a perspective view of an alternative embodiment of a multi-spade backspotfacing tool with a drilling apparatus.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein may be defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in any printed publication, dictionary, or issued patent.

### 2. Certain Specific Embodiments

Now, certain specific embodiments are described, which are by no means an exclusive description of the inventions. Other specific embodiments, including those referenced in the drawings, are encompassed by this application and any patent that issues therefrom.

One or more specific embodiments disclosed herein includes a method of creating a backspotface, comprising providing a backspotface bar, wherein the backspotface bar comprises a first end, wherein the first end comprises an axial slit and a first borehole for receiving a first set screw, and a second end, wherein the second end comprises a second borehole for receiving a second set screw; inserting the second end of the backspotface bar into the chuck of a drill, wherein the backspotface bar is inserted to a depth allowing for the second borehole to line up with a drill borehole in the chuck of the drill; securing the backspotface bar within the chuck of the drill; inserting the first end of the backspotface bar through a hole in a workpiece, wherein the first borehole and the axial slit are positioned on the backside of the workpiece; inserting a spade into the axial slit, wherein the cutting edges of the spade face the workpiece; securing the spade in the axial slit by threading the first set screw into the first borehole until the first set screw engages the spade; and activating the drill and engaging the spade with the workpiece.

One or more specific embodiments disclosed herein includes a method of creating a backspotface, comprising first, providing a backspotface bar, wherein the backspotface bar comprises a first end, wherein the first end comprises an axial slit and a first borehole for receiving a first set screw, and a second end, wherein the second end comprises a second borehole for receiving a second set screw; second, providing a workpiece, wherein the workpiece comprises a hole; third, inserting a spade into the axial slit, wherein the cutting edges of the spade face away from the first end; fourth, securing the spade in the axial slit by threading the first set screw into the first borehole until the first set screw engages the spade; fifth, inserting the second end of the backspotface bar through the hole in the workpiece, wherein the first borehole and the axial slit are positioned on the backside of the workpiece; sixth, inserting the second end of the backspotface bar into the chuck of a drill, wherein the backspotface bar is inserted to a depth allowing for the second borehole to line up with a drill borehole in the chuck of the drill; seventh, securing the backspotface bar within the chuck of the drill; and eighth, activating the drill and engaging the spade with the workpiece.

One or more specific embodiments disclosed herein includes a method of creating a backspotface, comprising providing a backspotface bar, wherein the backspotface bar comprises a first end, wherein the first end comprises a slit and a plurality of boreholes, and a second end; inserting the second end of the backspotface bar into the chuck of a drill; securing the backspotface bar within the chuck of the drill; inserting the first end of the backspotface bar through a hole in a workpiece, wherein the first borehole and the slit are positioned on the backside of the workpiece; inserting a spade into the slit, wherein the cutting edges of the spade face the workpiece; securing the spade in the slit by threading a set screw into each of the plurality of boreholes; and activating the drill and engaging the spade with the workpiece.

In any one of the tools or methods disclosed herein, the backspotface bar may comprise a cylindrical shape.

In any one of the tools or methods disclosed herein, a round bushing may be slid onto the cylindrical backspotface bar.

In any one of the methods disclosed herein, the method may further comprise sliding the round bushing into the chuck of the drill, wherein the round bushing may engage the inner surface of the chuck of the drill and the outer surface of the backspotface bar, prior to securing the backspotface bar within the chuck of the drill.

### 3. Specific Embodiments in the Figures

The drawings presented herein are for illustrative purposes only and are not intended to limit the scope of the claims. Rather, the drawings are intended to help enable one having ordinary skill in the art to make and use the claimed inventions.

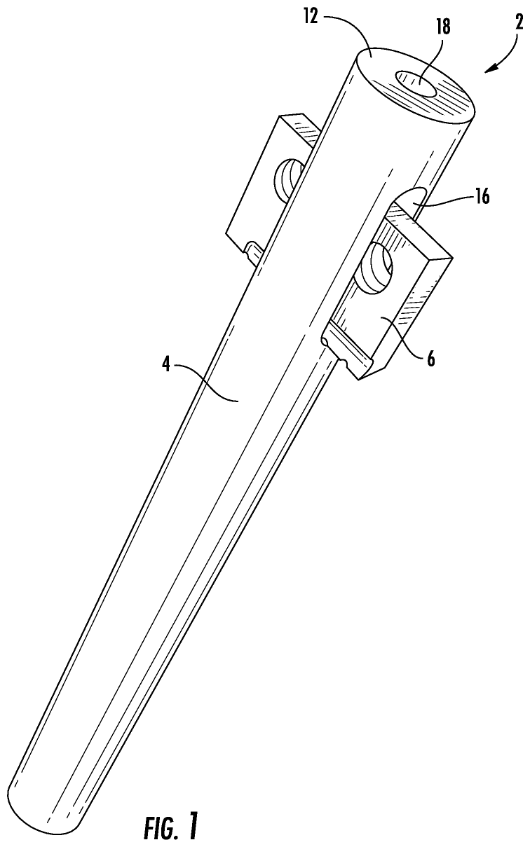

Referring to FIGS. 1-13, specific embodiments, e.g., version or example, of a multi-spade backspotfacing tool are illustrated. These figures may show features which may be found in various specific embodiments, including the embodiments shown in this specification and those not shown.

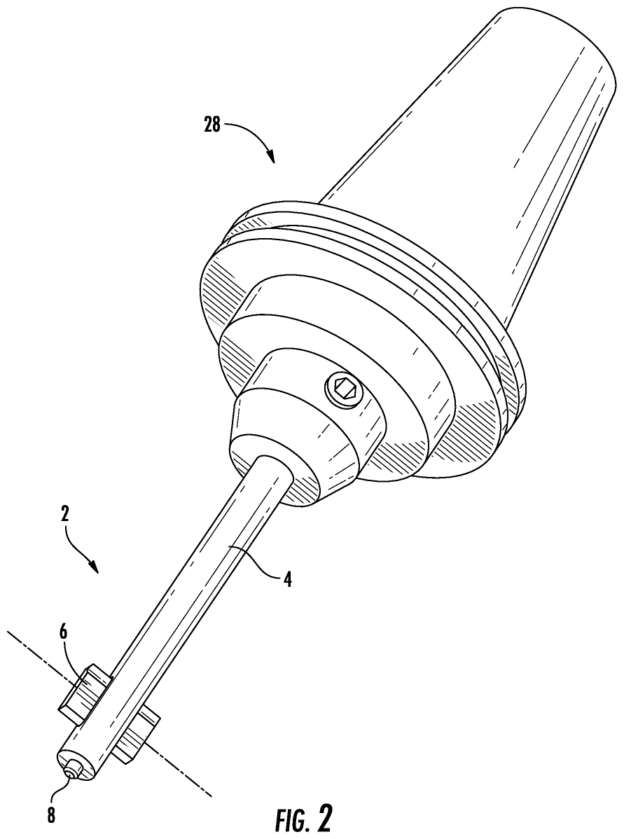

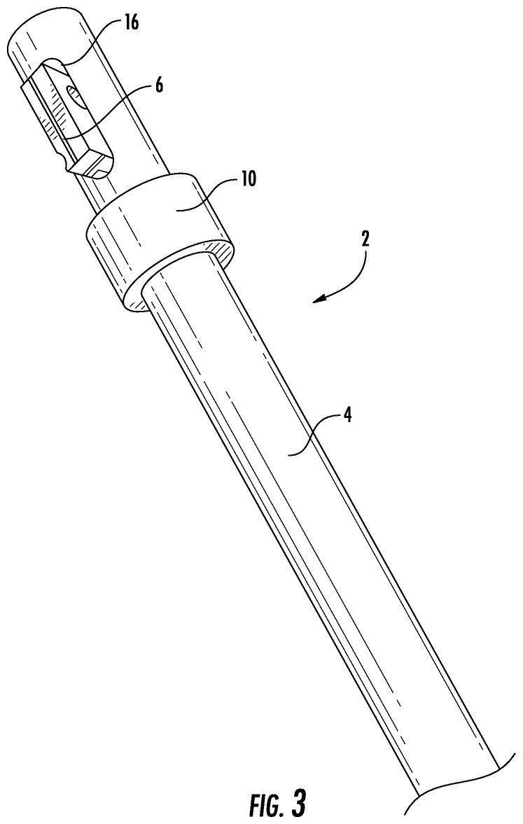

FIG. 1 illustrates a perspective view of an embodiment of a multi-spade backspotfacing tool 2. In embodiments, the multi-spade backspotfacing tool 2 may comprise a backspotface bar 4, a spade 6, a set screw 8 (see FIG. 2), and a bushing 10 (see FIG. 3). In embodiments, the multi-spade backspotfacing tool 2 may be employed for backspotfacing.

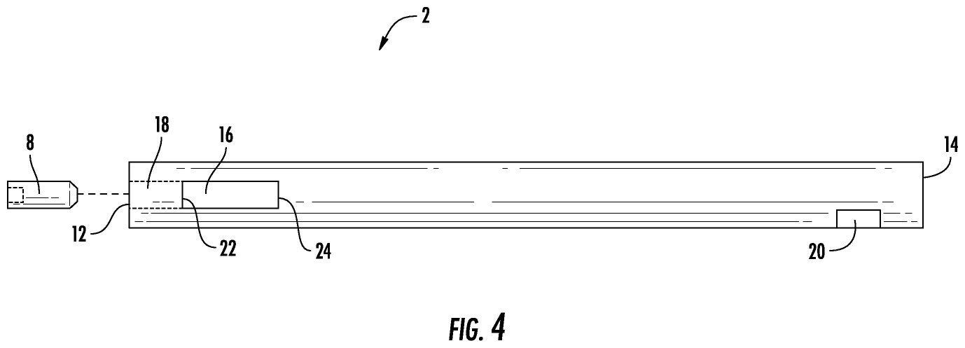

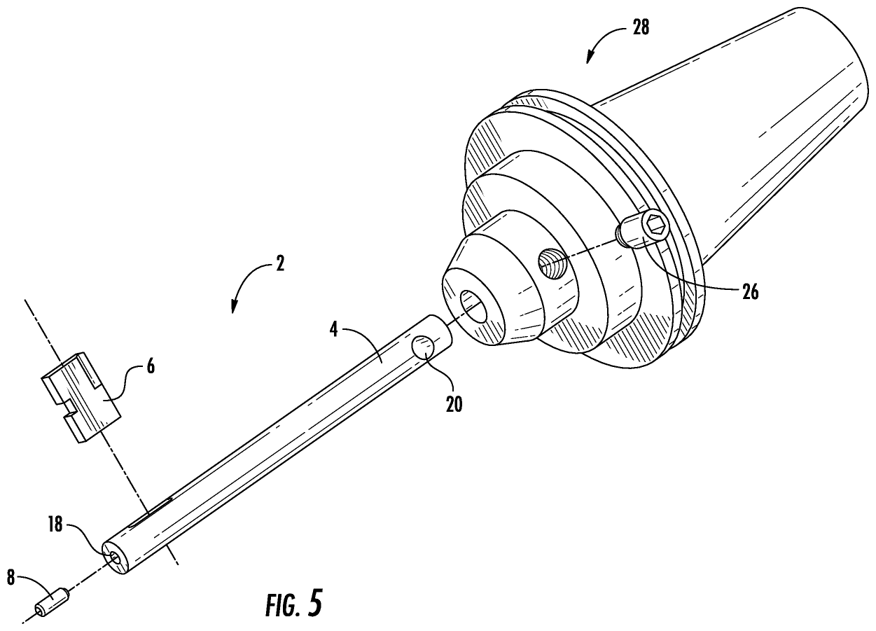

In embodiments, the backspotface bar 4 may have the shape of a cylindrical column as shown in FIG. 1. In embodiments, the backspotface bar 4 may be made to accept certain industrial standard T-A® and universal series flat-bottom spades, as discussed below. In embodiments, the backspotface bar 4 may comprise a first end 12 and a second end 14 as shown in FIG. 4. In embodiments, the backspotface bar 4 may also comprise an axial slit 16 as shown in FIG. 1, which may be closer to the first end 12 as opposed to the second end 14. Additionally, in embodiments the backspotface bar 4 may comprise a first bore 18, which may be positioned at the first end 12 as illustrated in FIG. 1. Further, the backspotface bar 4 may also comprise a second bore 20 on the outer axial surface as shown in FIGS. 4 and 5.

In embodiments, the first end 12 of the backspotface bar 4 may comprise a flat surface as illustrated in FIG. 1. Further, in embodiments the second end 14 may comprise a flat surface as illustrated in FIG. 4.

In embodiments, the axial slit 16 may comprise a stadium shape, as shown in FIG. 1. Alternatively, in embodiments the axial slit 16 may comprise a rectangular shape with or without rounded corners (see FIG. 4). In embodiments, the axial slit 16 may comprise a first slit end 22 and a second slit end 24 as illustrated in FIG. 4. In embodiments, the axial slit 16 may be located axially along the center of the backspotface bar 4 as illustrated in FIG. 1. Further, in embodiments the axial slit 16 may extend entirely through the backspotface bar 4 as shown in FIG. 1. In embodiments, the axial slit 16 extending through the backspotface bar 4 may allow the spade 6 to extend from one side of the backspotface bar 4 to the other side of the backspotface bar 4 as shown in FIG. 1.

In embodiments, the first bore 18 may comprise a circular shape as shown in FIG. 1. Further, in embodiments the first bore 18 may be placed concentrically in the center of the first end 12 of the backspotface bar 4 as shown in FIG. 1. Additionally, in embodiments the first bore 18 may extend into the backspotface bar 4 until the first bore 18 connects and terminates with the interior of the axial slit 16 as shown in FIG. 4. In embodiments, the first bore 18 may also be threaded to receive the set screw 8.

In embodiments, the second bore 20 at the second end 14 of backspotface bar 4 may comprise a shape to receive a drill-bit set screw 26 as shown in FIG. 5. In embodiments, the drill-bit set screw 26 may comprise the following types of tips: plain cup, knurled cup, flat, oval, cone, half-dog, or soft-tipped. Thus, the second bore 20 may comprise a shape to receive any of these types of tips of the drill-bit set screw 26. In the embodiment shown in FIG. 5, the second bore 20 comprises a round shape.

In embodiments, the spade 6 may comprise any type of spade drill blade. In embodiments, the spade 6 may comprise any of the sizes shown in the following table:

TABLE 1

| | Spade Drill Blade Sizes |
|---|---|
| T-A ® Backspotface Bars | |
| #1 | 45/65″ thru 15/16″ |
| #2 | 31/32″ thru 1⅜″ |
| #3 | 1 13/32″ thru 1⅞″ |
| #4 | 1 29/32″ thru 2 9/16″ |
| #5 | 2½″ thru 3½″ |
| #7 | 3 17/32″ thru 4½″ |
| Universal Backspotface Bars | |
| A | 31/32″ thru 1¼″ |
| B | 1¼″ thru 1½″ |
| C | 1½″ thru 2″ |
| D | 2″ thru 2½″ |
| E | 2½″ thru 3″ |
| F | 3″ thru 3½″ |
| G | 3½″ thru 4″ |
| H | 4″ thru 5″ |

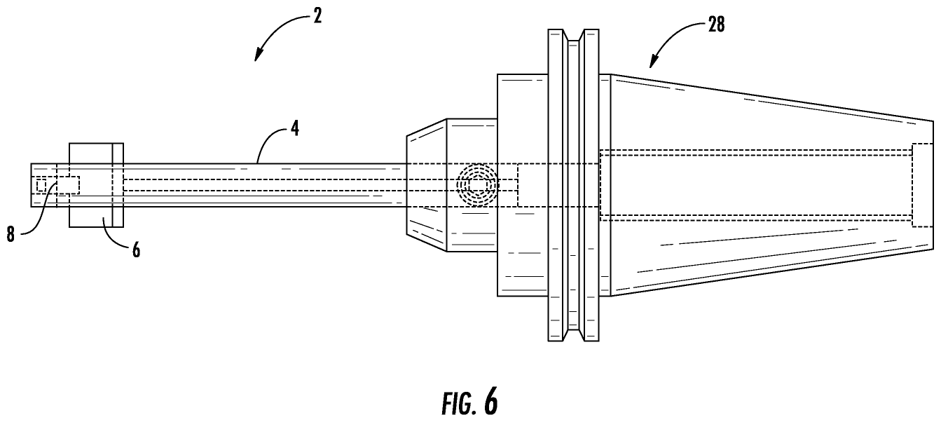

In embodiments, the spade 6 may be inserted into the axial slit 16 in such a way that the spade 6 is centered within the axial slit 16 so that the sides of the spade 6 are equally extending out from the axial slit 16 as shown in FIGS. 1, 2, and 6. Further, in embodiments, the spade 6 may be inserted into the axial slit 16 so that the blade end of the spade 6 is facing the second end 14 of the backspotface bar 4. In embodiments, the set screw 8 may be threaded into the first bore 18 until the set screw 18 contacts the spade 6 as shown in FIG. 6, wherein the set screw 8 may be tightened against the spade 6 to lock the spade 6 in place.

In embodiments, the first set screw 8 may comprise threads, which may allow the first set screw 8 to be threaded into the first bore 18. FIG. 4 illustrates an embodiment of the first set screw 8.

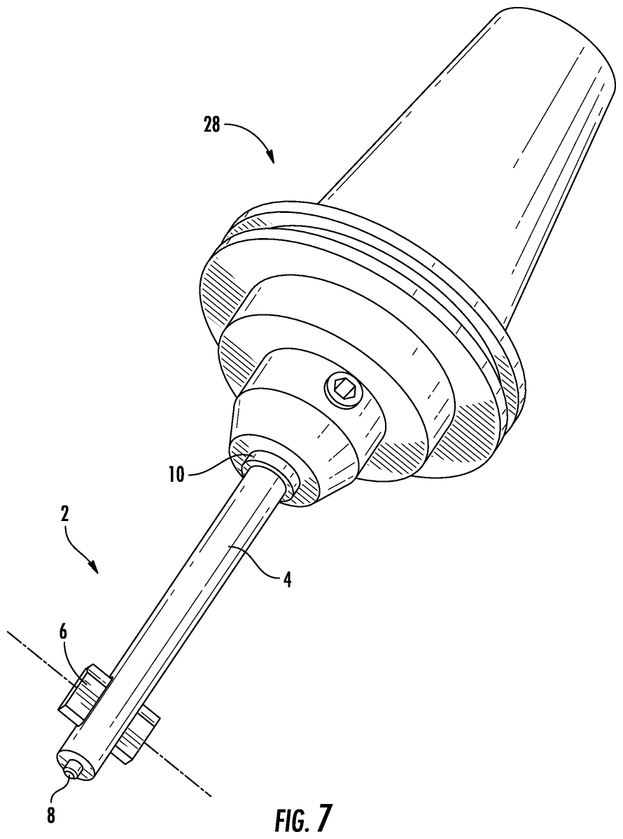

Additionally, in embodiments, the bushing 10 may be employed to secure the backspotface bar 4 in place within a drilling apparatus 28 as shown in FIG. 7. The bushing 10 may comprise an inner diameter slightly bigger than the outer diameter of backspotface bar 4 such that the bushing 10 may be slid onto the outer diameter of backspotface bar 4 such that the inner diameter of the bushing 10 and outer diameter of the backspotface bar 4 abut each other. In embodiments, the bushing 10 may be placed on the outside of the backspotface bar 4 as shown in FIG. 7. In embodiments, once the first end 12 and axial slit 16 have been moved through a hole 40 in a workpiece 30 to be drilled, the bushing 10 may be placed on the backspotface bar 4 as shown in FIG. 7 and then moved into the bore of the drilling apparatus 28 for the purpose of securing the backspotface bar 4 within the drilling apparatus 28.

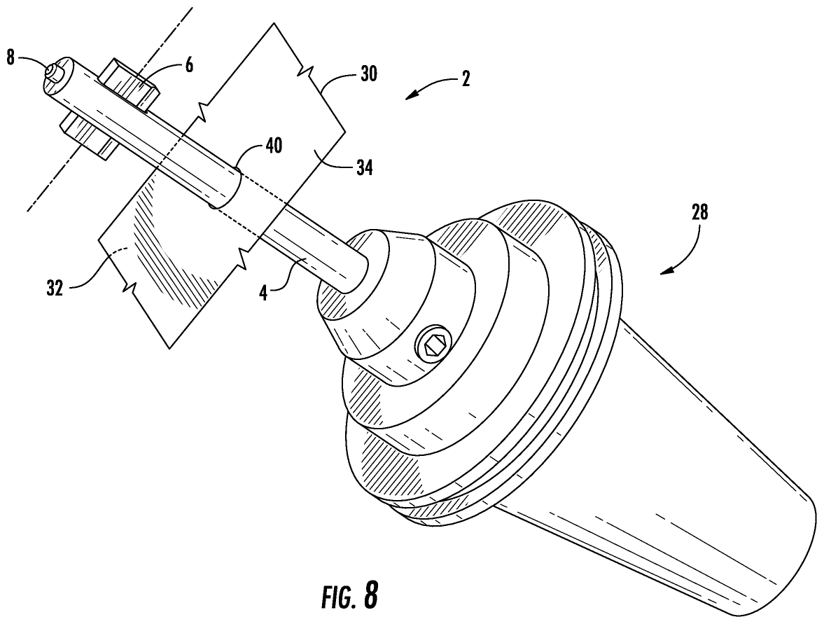

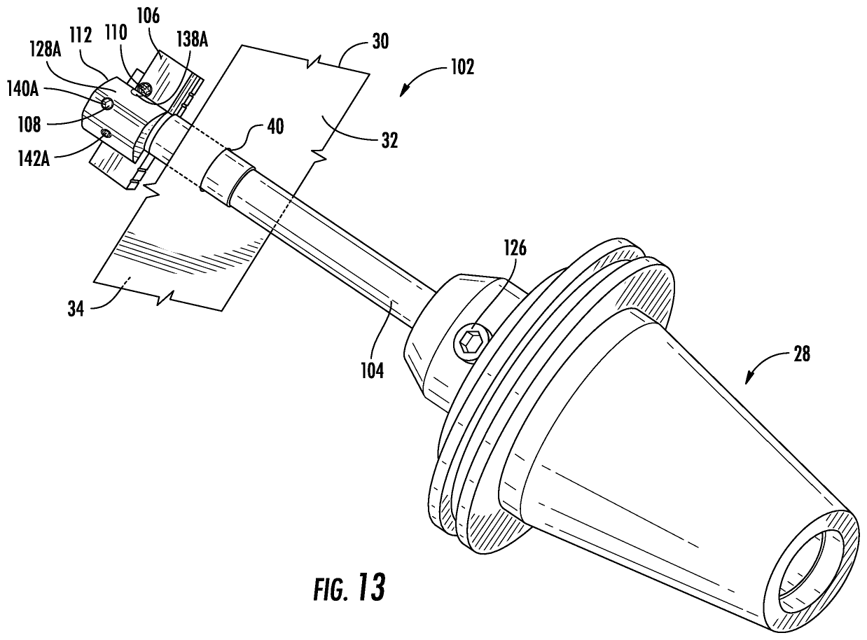

In practice, embodiments of the workpiece 30 may comprise two sides as shown in FIG. 8. Please note that the embodiments of workpiece 30 illustrated in FIGS. 8 and 13 are not drawn to scale. In embodiments, the side facing the drill apparatus 28 may be referred to as a drill side 32, and the other side of the workpiece 30 may be referred to as a back side 34. In embodiments, a user may send the first end 12 of the backspotface bar 4 through the hole 40 in the workpiece 30 so that the first end 12 enters the hole 40 on the drill side 32 and exits from the back side 34 of the hole 40. In embodiments, once the first end 12 and the axial slit 16 are on the back side of the workpiece 30, the spade 6 may be secured within the axial slit 16 by use of the set screw 8. Further, in embodiments the bushing 10 may be employed to secure the backspotface bar 4 in the drilling apparatus 28. Next, in embodiments, the backspotface bar 4 with the bushing 10 may be secured to the drill apparatus 28 by employing the drill bit set screw 26, which may be screwed into the second bore 20. Once the backspotfacing tool 2 has been set up for use, in embodiments the backspotfacing operation may commence. In alternative embodiments, the spade 6 may be secured in the axial slit 16, and then the second end 14 of the backspotface bar 4 may be sent through the hole 40 in the workpiece 30 so that the second end 14 enters from the back side 34 and exits from the drill side 32. In embodiments, the backspotface bar 4 and the bushing 10 may then be secured in the drilling apparatus 28.

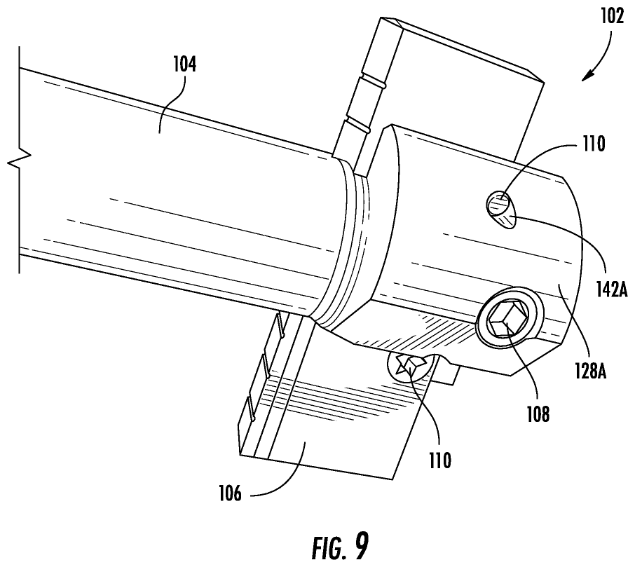

FIG. 9 illustrates a perspective view of an alternative embodiment referred to as a multi-spade backspotfacing tool 102. In embodiments, the multi-spade backspotfacing tool 102 may comprise a backspotface bar 104, a spade 106, a main set screw 108, and a plurality of spade set screws 110. In embodiments, the multi-spade backspotfacing tool 102 may be employed for backspotfacing.

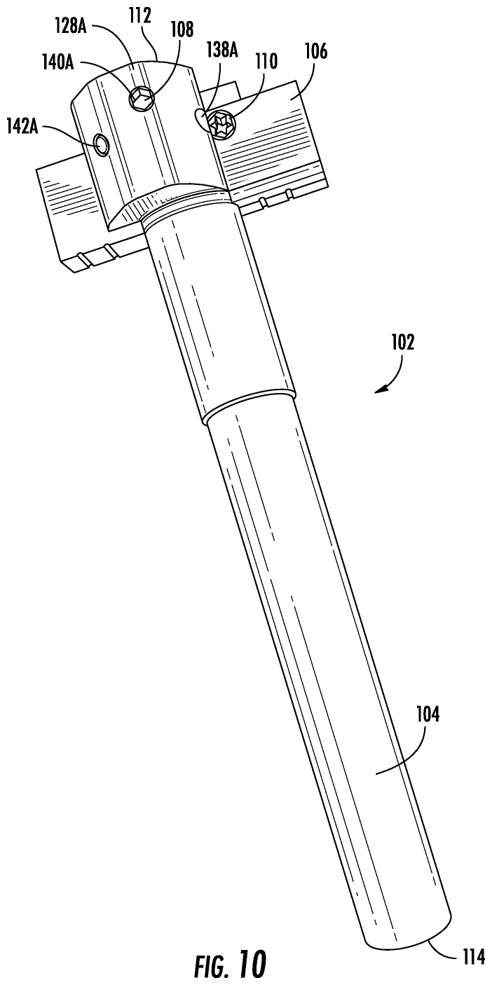

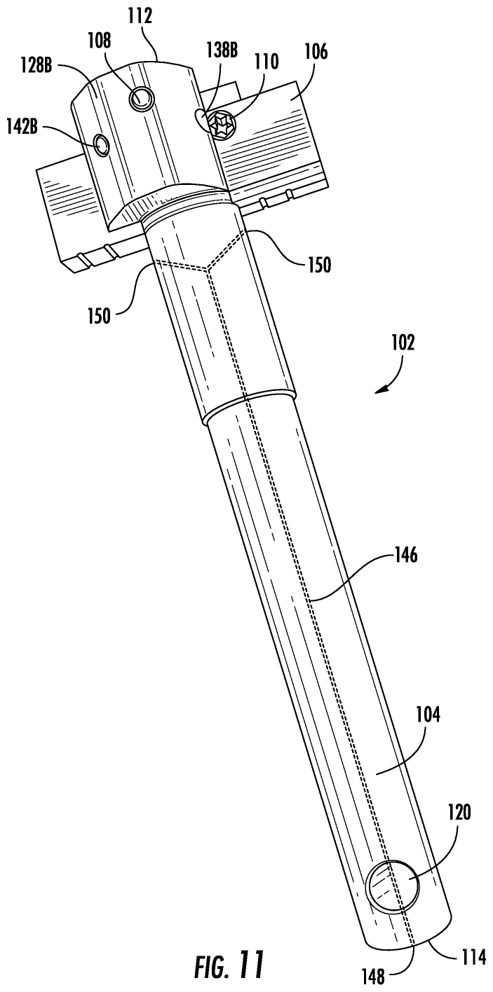

In embodiments, the backspotface bar 104 may have the shape of a cylindrical column as shown in FIG. 10. Further, in embodiments the backspotface bar 104 may have multiple sections with different outer diameters as shown in FIG. 10. In embodiments, the backspotface bar 104 may comprise a first end 112 and a second end 114. Further, the backspotface bar 104 may also comprise a bore 120 on the outer axial surface as shown in FIG. 11. Additionally, the embodiment in FIG. 11 illustrates a coolant hole 146. In embodiments, the coolant hole 146 comprises an injection port 148 and one or more ejection ports 150. In embodiments, coolant may be provided to the coolant hole 146 at injection port 148 and then ejected from the one or more ejection ports 150, which may provide coolant for the operation of the spade 106.

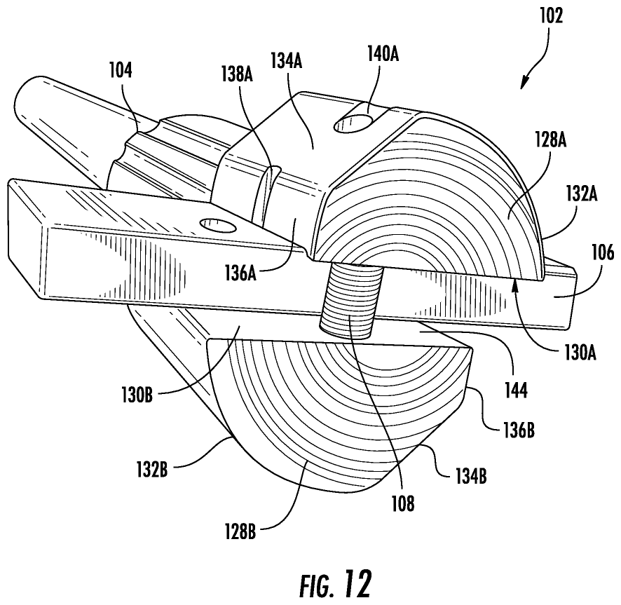

In embodiments, the first end 112 of the backspotface bar 104 may comprise a first offset 128A and a second offset 128B as show in FIG. 12. In embodiments, the offsets 128A and 128B may form a part of the backspotface bar 104. In embodiments, the offset 128A may comprise multiple sides including, but not limited to, several straight sides and at least one curved side. For example, in embodiments the offset 128A may comprise a flat surface 130A, wherein the flat surface 130A may face the offset 128B. In embodiments, the offset 128A may further comprise a curved surface 132A, a first angled surface 134A, and a second angled surface 136A. Additionally, the offset 128A may comprise a channel 138A. In embodiments, the channel 138A may comprise a semicircular shape. In embodiments, the channel 138A may be formed within the second angled surface 136A. In embodiments, the different surfaces of the offset 128A may allow for the injection of water and/or a clearance for metal shavings. Additionally, in embodiments, the offset 128A may comprise a main borehole 140A, which may extend through the entirety of the offset 128A. In embodiments, the main borehole 140A may be threaded to receive the main set screw 108. Further, in embodiments the offset 128A may comprise a set screw borehole 142A as shown in FIG. 9.

In embodiments, the offset 128B may comprise multiple sides including, but not limited to, several straight sides and at least one curved side. For example, in embodiments the offset 128B may comprise a flat surface 130B, wherein the flat surface 130B may face the offset 128A. In embodiments, the offset 128B may further comprise a curved surface 132B, a first angled surface 134B, and a second angled surface 136B. Additionally, the offset 128B may comprise a channel 138B. In embodiments, the channel 138B may comprise a semicircular shape. In embodiments, the channel 138B may be formed within the second angled surface 136B. In embodiments, the different surfaces of the offset 128B may allow for the injection of water and/or a clearance for metal shavings. Additionally, in embodiments, the offset 128B may comprise a main borehole 140B, which may extend through the entirety of the offset 128B. In embodiments, the main borehole 140B may be threaded to receive the main set screw 108. Further, in embodiments the offset 128B may comprise a set screw borehole 142B.

In embodiments, a notch 144 may exist between the offset 128A and the offset 128B as shown in FIG. 12. In embodiments the spade 106 may be placed within the notch 144 prior to the installation of the main set screw 108. In embodiments, the size of the notch 144 employed will depend on the size of the spade 106 to be installed in the notch 144. In embodiments, the spade 106 may extend from one side of the backspotface bar 104 to the other side of the backspotface bar 104 as shown in FIGS. 9, 10, and 12 In embodiments, the spade 106 may comprise any type of spade drill blade. In embodiments, the spade 106 may be inserted into the notch 144 in such a way that the spade 106 is centered within the notch 142 so that the sides of the spade 106 are equally extending out from the offsets 128A and 128B. Further, in embodiments, the spade 106 may be inserted into the notch 142 so that the blade end of the spade 106 is facing the second end 114 of the backspotface bar 104. In embodiments, the spade 106 may be set in place by the use of two spade set screws 110. For example, in embodiments the channel 138A of the offset 128A may provide additional space for the threaded insertion of one of the spade set screws 110 into the spade 106 and then into the set screw borehole 142B. Similarly, in embodiments the channel 138B of the offset 128B may provide additional space for the threaded insertion of one of the spade set screws 110 into the spade 106 and then into the set screw borehole 142A. In embodiments, once the spade 106 is secured in place by the plurality of spade set screws 110, the main set screw 108 may be inserted into the main borehole 140A, extend through the notch 144, and into the main borehole 140B, where the main set screw is threadedly engaged with the main borehole 140B. In embodiments, the main set screw 108 further secures the spade 106 in place.

In embodiments, the offsets 128A and 128B are offset from each other, which may allow for the insertion of the spade set screws 110.

In practice, the piece of metal 30 may comprise two sides as shown in FIG. 13. The side facing the drill apparatus 28 may be referred to as the drill side 32, and the other side of the piece of metal 30 may be referred to as the back side 34. In embodiments, the spade 106 may be secured in the notch 144, and then the second end 114 of the backspotface bar 104 may be sent through the hole 40 in the workpiece 30 so that the second end 114 enters from the back side 34 and exits from the drill side 32. Next, in embodiments, the backspotface bar 104 may be secured to the drill apparatus 28 by employing a drill bit set screw 126, which may be screwed into the second bore 120. Once the backspotfacing tool 102 has been set up for use, in embodiments the backspotfacing operation may commence.

Generally, the above describes improved methods and tools for backspotfacing. More specifically, some of the benefits of the above-described methods and tools are the orientation of the cutting end of the spade 6 facing the drilling apparatus 28 as well as providing clearance for the removal of metal shavings.

What is claimed is:

1. A method of creating a backspotface, comprising:
providing a backspotface bar, wherein the backspotface bar comprises a first end, wherein the first end comprises an axial slit and a first borehole for receiving a first set screw, and a second end, wherein the second end comprises a second borehole for receiving a second set screw;
inserting the second end of the backspotface bar into the chuck of a drill, wherein the backspotface bar is inserted to a depth allowing for the second borehole to line up with a drill borehole in the chuck of the drill;
securing the backspotface bar within the chuck of the drill;
inserting the first end of the backspotface bar through a hole in a workpiece, wherein the first borehole and the axial slit are positioned on the backside of the workpiece;
inserting a spade into the axial slit, wherein the cutting edges of the spade face the workpiece;
securing the spade in the axial slit by threading the first set screw into the first borehole until the first set screw engages the spade; and
activating the drill and engaging the spade with the workpiece.

2. The method of claim 1, wherein the backspotface bar comprises a cylindrical shape.

3. The method of claim 2, wherein the method further comprises sliding a round bushing onto the cylindrical spade.

4. The method of claim 3, wherein the method further comprises sliding the round bushing into the chuck of the drill, wherein the round bushing engages the inner surface of the chuck of the drill and the outer surface of the backspotface bar, prior to securing the backspotface bar within the chuck of the drill.

5. A method of creating a backspotface, comprising:
first, providing a backspotface bar, wherein the backspotface bar comprises a first end, wherein the first end comprises an axial slit and a first borehole for receiving a first set screw, and a second end, wherein the second end comprises a second borehole for receiving a second set screw;
second, providing a workpiece, wherein the workpiece comprises a hole;
third, inserting a spade into the axial slit, wherein the cutting edges of the spade face away from the first end;
fourth, securing the spade in the axial slit by threading the first set screw into the first borehole until the first set screw engages the spade;
fifth, inserting the second end of the backspotface bar through the hole in the workpiece, wherein the first borehole and the axial slit are positioned on the backside of the workpiece;
sixth, inserting the second end of the backspotface bar into the chuck of a drill, wherein the backspotface bar is inserted to a depth allowing for the second borehole to line up with a drill borehole in the chuck of the drill;
seventh, securing the backspotface bar within the chuck of the drill; and
eighth, activating the drill and engaging the spade with the workpiece.

6. The method of claim 5, wherein the backspotface bar comprises a cylindrical shape.

7. The method of claim 6, wherein the method further comprises a step of sliding a round bushing onto the second end of the cylindrical spade after inserting the second end of the backspotface bar through the hole in the workpiece.

8. The method of claim 7, wherein the method further comprises sliding the round bushing into the chuck of the drill, wherein the round bushing engages the inner surface of the chuck of the drill and the outer surface of the backspotface bar, prior to securing the backspotface bar within the chuck of the drill.

9. A method of creating a backspotface, comprising:
providing a backspotface bar, wherein the backspotface bar comprises a first end, wherein the first end comprises a slit and a plurality of boreholes, and a second end;
inserting the second end of the backspotface bar into the chuck of a drill;
securing the backspotface bar within the chuck of the drill;
inserting the first end of the backspotface bar through a hole in a workpiece, wherein the first borehole and the slit are positioned on the backside of the workpiece;
inserting a spade into the slit, wherein the cutting edges of the spade face the workpiece;
securing the spade in the slit by threading a set screw into each of the plurality of boreholes; and
activating the drill and engaging the spade with the workpiece.

10. The method of claim 9, wherein the backspotface bar comprises a cylindrical shape.

11. The method of claim 10, wherein the backspotface bar further comprises a coolant hole.
